(19) United States
(12) Patent Application Publication
(10) Pub. No.: US 2026/0170144 A1
(43) Pub. Date: Jun. 18, 2026

(54) Third-Party Application Library Security Management

(71) Applicant: Oracle International Corporation, Redwood Shores, CA (US)

(72) Inventors: Harish Santhanagopal, Fremont, CA (US); Margaret Sue Lloyd, Mercer Island, WA (US); Srikanth S. Nandula, San Jose, CA (US); Kyasaram Vishwa Prasad, Hyderabad (IN); Guru Selvaraj, Hyderabad (IN)

(73) Assignee: Oracle International Corporation, Redwood Shores, CA (US)

(21) Appl. No.: 18/984,597

(22) Filed: Dec. 17, 2024

(51) Int. Cl. G06F 21/57

(52) U.S. Cl. CPC G06F 21/577; G06F 2221/033

(57) ABSTRACT

Techniques for remediating vulnerabilities in software are disclosed. A system maps third-party software modules to applications in which the third-party software modules are implemented. Upon identifying a vulnerability associated with a particular third-party software module, a system (a) identifies the applications mapped to the third-party software module and (b) initiates a process to remediate the vulnerability in the applications mapped to the third-party software module. The system recommends remediation paths for remediating the vulnerability by applying vulnerability data and mapping data to a generative artificial intelligence (AI) model. If an instance of the third-party software module is stored in the registry, the system scans the instance to determine if the vulnerability exists in the instance.

### TECHNICAL FIELD

The present disclosure relates to software security. In particular, the present disclosure relates to identifying and remediating vulnerabilities in software that uses third-party software components.

### BACKGROUND

Crowd-sourced software development allows an organization to open software development projects to large numbers of individuals. Crowd-sourcing facilitates faster development of reusable software components. Third-party libraries that are developed outside an enterprise are implemented within the enterprise's software applications. Consequently, developers within the enterprise do not need to develop software for desired function from scratch. However, third-party libraries, such as open-source libraries, may lack stringent security oversight. Consequently, applications that use third-party libraries may be susceptible to security breaches, such as malware, viruses, and software hackers obtaining unauthorized access to an enterprise's data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1C illustrate a software security management system in accordance with one or more embodiments;

FIGS. 2A and 2B illustrate an example set of operations for remediating vulnerabilities in third-party software modules in accordance with one or more embodiments;

FIGS. 3A and 3B illustrates an example set of operations for training a transformer-type machine learning model to recommend remediation paths for vulnerabilities in accordance with one or more embodiments;

FIGS. 4A-4D illustrates an example embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SOFTWARE SECURITY MANAGEMENT ARCHITECTURE
3. REMEDIATING VULNERABILITIES FROM THIRD-PARTY SOFTWARE MODULES
4. TRAINING A GENERATIVE AI MODEL TO RECOMMEND REMEDIATION PATHS
5. EXAMPLE EMBODIMENT
6. COMPUTER NETWORKS AND CLOUD NETWORKS
7. MICROSERVICE APPLICATIONS
8. HARDWARE OVERVIEW
9. MISCELLANEOUS; EXTENSIONS

### 1. General Overview

One or more embodiments identify application vulnerabilities based on a mapping of third-party software modules to the applications that implement the third-party software modules. Upon identifying a vulnerability associated with a particular third-party software module, a system (a) identifies the applications mapped to the third-party software module and (b) initiates a process to remediate the vulnerability in the applications mapped to the third-party software module. The system may identify remediation paths for remediating the vulnerability by applying vulnerability data and mapping data to a generative artificial intelligence (AI) model such as a large language model (LLM). For example, an organization may store a registry of third-party software modules and libraries that are implemented in applications supported by, or under development by, the organization. A system may query a vulnerability database to identify a vulnerability associated with a third-party software module stored in the registry. If an instance of the third-party software module is stored in the registry, the system may scan the instance to determine if the vulnerability exists in the instance. If the system determines an instance of the third-party software module is not stored in the registry, the system may transmit a notification to an owner of an application mapped to the third-party module to recommend the remediation path for the third-party module.

One or more embodiments retrain a generative AI model based on real-time vulnerability and system data. For example, upon identifying and remediating an identified vulnerability in an application that uses a third-party software module, a system may generate new training data based on vulnerability data, third-party software module data, and application data. In some embodiments, a generative AI model may identify a vulnerability in an application that a vulnerability database has not yet identified. For example, a system may obtain vulnerability data from an external database that stores and updates identified vulnerabilities of publicly-used, third-party applications. The system may generate a set of input data to provide to the generative AI model. The set of input data may include vulnerability data obtained from the database and application data specifying applications used within an organization's cloud environment. The generative AI model may identify a remediation path for one application that uses a third-party software module identified in the vulnerability database. The generative AI model may identify a different remediation path for a different application that uses a third-party software module that was not identified in the vulnerability database. The generative AI model may identify the different application based on the relationships learned and embodied in the structure of the generative AI model during training the generative AI model.

One or more embodiments described in this Specification and/or recited in the claims may not be included in this General Overview section.

### 2. Software Security Management Architecture

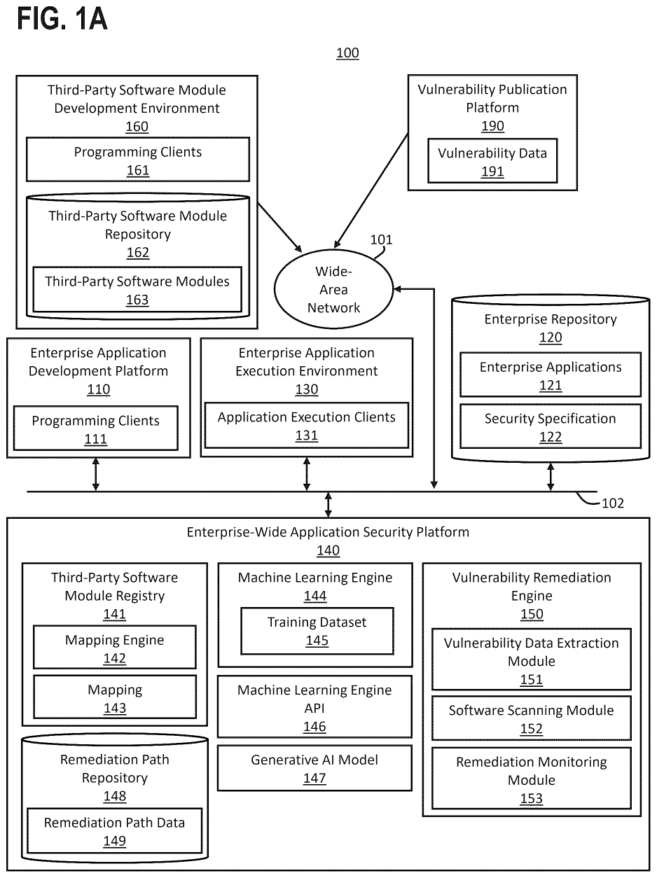

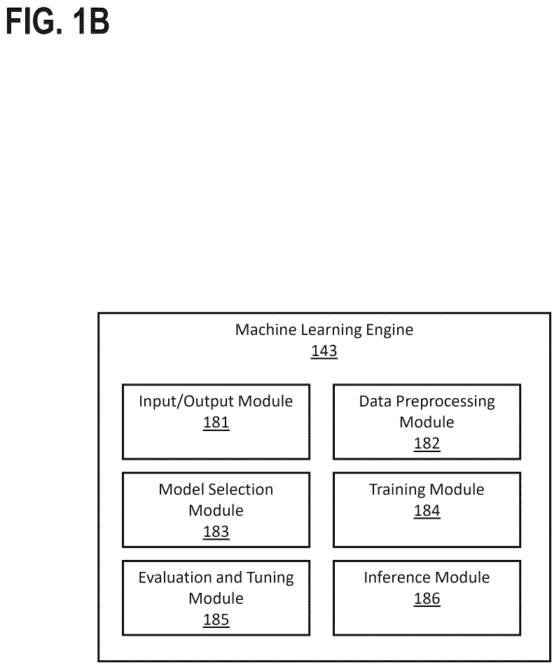

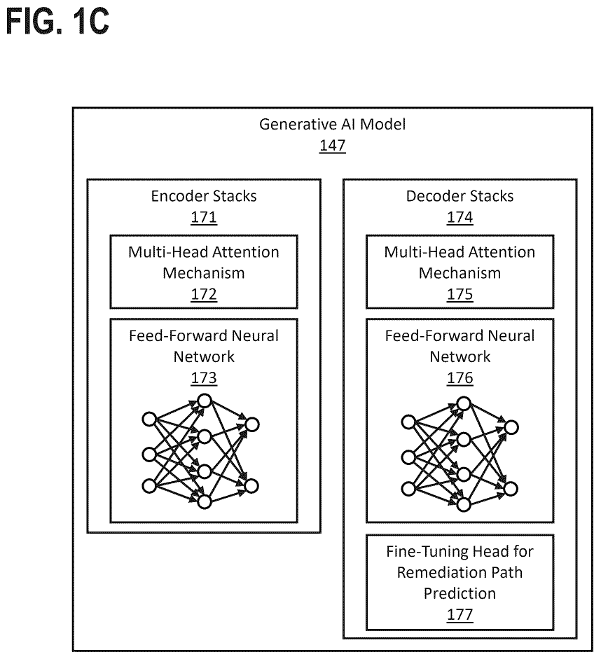

FIGS. 1A-1C illustrate a system 100 in accordance with one or more embodiments. As illustrated in FIG. 1A, system 100 includes an enterprise application development platform 110, an enterprise repository 120, an enterprise application execution environment 130, and an enterprise-wide application security platform 140. The system 100 further includes a third-party software module development environment 160 and a vulnerability publication platform 190. The system components communicate via a wide-area network 101 such as the Internet. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

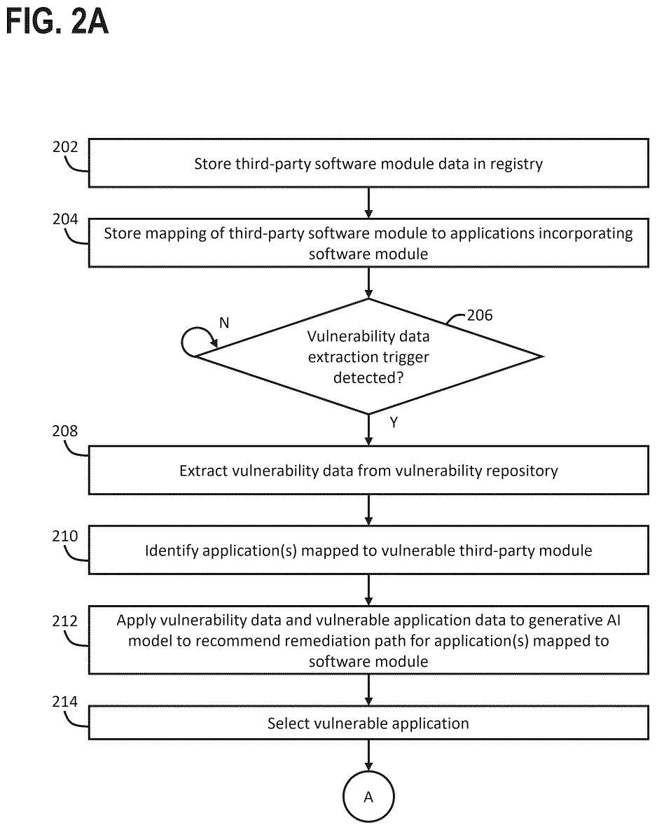

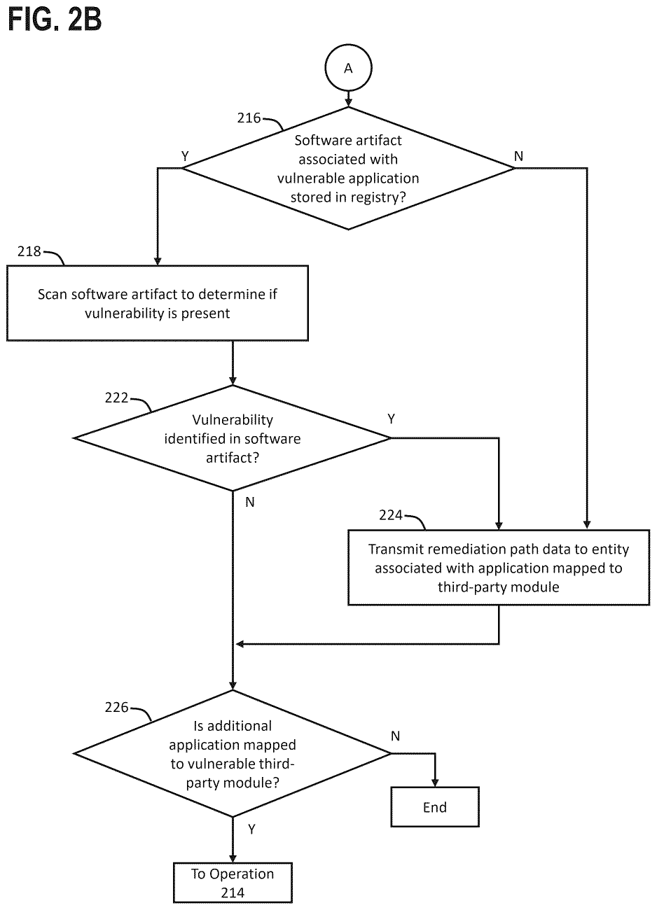

In one or more embodiments, enterprise-wide application security platform 140 refers to hardware and/or software configured to perform operations described herein for managing software security in an enterprise. Examples of operations for managing software security in an enterprise are described below with reference to FIGS. 2A-2B.

In an embodiment, the enterprise-wide application security platform 140 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a mainframe, a mobile handset, a smartphone, a personal digital assistant (PDA), a wireless receiver and/or transmitter, a base station, and/or a communication management device.

An enterprise application development platform 110 includes hardware and software for developing applications to be implemented by an enterprise and/or incorporated in software that the enterprise distributes to external entities, such as clients and customers. Programming clients 111 include personal computers and servers running application development software. Application development software includes applications and programs that allow software developers to write, test, and compile software code for software applications.

An enterprise repository 120 is a data repository that stores enterprise applications 121. Enterprise applications 121 may include applications that are used within an enterprise. Examples of applications used within an enterprise include a human resources management application, an accounting application, an application to store and retrieve data in one or more databases, an application that presents data stored in databases to users via a graphical user interface (GUI), a customer or client management application, an operations management application, an inventory management application, an application that manages communications among members of an enterprise, such as video, email, and instant messaging, a product development application, a project management application, a report generation application, and a security management application. The above applications are provided by way of example. Embodiments encompass any applications that may be developed by an enterprise to allow a computing system managed by the enterprise to perform operations for the enterprise.

An enterprise application execution environment 130 is an environment in which application execution clients 131 execute enterprise applications 121. In one example, an enterprise manages a cloud environment. Applicant execution clients 131 include desktop computers, laptops, and handheld devices operated by employees. Employees access applications managed in the cloud environment to perform enterprise operations, such as accessing, modifying, and generating content. Employees may download enterprise applications 121 onto application execution clients 131. Additionally, or alternatively, employees may download agents or sub-applications of the enterprise applications 121 onto local desktop computers, laptops, and handheld devices. Additionally, or alternatively, employees may stream content from the cloud environment without downloading applications or agents from the cloud environment.

According to another example, the application execution environment 130 is a set of computing devices connected via a network. For example, an enterprise may maintain a set of personal computers, laptops, and handheld devices at a geographic location such as an office. The computing devices may be connected via a local area network (LAN). The enterprise may store enterprise applications 121 on a centralized server for distribution to connected computing devices.

In one or more embodiments, enterprise applications 121 incorporate third-party software modules 163 to provide functionality within enterprise applications 121. As an example, a software development team may develop an application to assist project managers to efficiently manage projects. The software development team may use third-party software modules 163 that provide a calendaring function, functionality to generate and modify a Gantt graph based on resources data, and functionality for an instant messaging system to manage messaging groups based on projects that employees are assigned to. The software development team may develop custom software without relying on third-party software modules to connect proprietary databases to a proprietary GUI to generate outward-facing communications to clients and customers as well as to track available resources within the enterprise for assignment to various projects. In other words, the application under development by the development team includes a combination of home-grown software code and third-party software modules.

In the present specification and claims, home-grown software code, also described as proprietary software code, is characterized by compliance with a set of proprietary security standards. In contrast, third-party software code, or third-party software modules, are characterized by a lack of compliance with the set of proprietary security standards. The set of proprietary security standards may correspond to a security specification 122 maintained by the enterprise-wide application security platform 140. The security specification 122 may specify, for example, authentication requirements for operations that involve communication across devices in a network, encryption requirements for data, and levels of security required for different types of data and/or functions performed by applications. The security specification 122 may specify a frequency that a consumer should check and an application for vulnerabilities and standards for responding to identified vulnerabilities. The security specification 122 may specify types of security checks to be performed on applications.

Third-party software modules 163 are developed in a third-party software module development environment 160 and stored in a third-party software modules repository 162. The third-party software module development environment 160 includes a computing system made up of programming clients 161, such as desktop computers and portable devices. The third-party software module development environment 160 is independent of the enterprise application development platform 110 and the enterprise application execution environment 130. For example, an enterprise may correspond to one company, and the third-party software module development environment 160 may include computing devices and a LAN maintained by another company. As another example, a third-party software module 163 may be an open-source software module. The third-party software module 163 may be developed by a company or independent developer and made available to the public.

The enterprise-wide application security platform 140 manages application security for applications (a) under development in the enterprise application development platform 110 and (b) executed in the enterprise application execution environment 130. The enterprise-wide application security platform 140 includes a third-party software module registry 141. The third-party software module registry 141 stores a mapping 143 of (a) third-party software modules to (b) applications that incorporate the third-party software modules. For example, the third-party software module registry 141 may store a mapping 143 of applications that are under development in the enterprise application development platform 110 and third-party software modules that are incorporated in the applications to perform functions of the applications.

The third-party software module registry 141 includes a mapping engine 142 to identify software module/application pairs to include in the mapping 143. In one embodiment, the mapping engine 142 analyzes vulnerability data 191 to identify third-party software modules 163 associated with the vulnerability. The mapping engine 142 may analyze outputs from third-party software modules 163 to identify one or more enterprise applications 121 that may utilize the output data. The mapping engine 142 may identify these enterprise applications 121 as candidates for mapping to a third-party software module 163. Additionally, the mapping engine 142 may analyze dependencies among enterprise applications 121 to identify candidates for mapping to a third-party software module 163. For example, a vulnerability in a software module 163 may result in a vulnerability in an application that incorporates the software module and in any dependent applications.

In some embodiments, a generative artificial intelligence (AI) model 147 identifies candidate applications for mapping to third-party software modules 163. For example, vulnerability data 191 may specify a type of data vulnerability associated with a third-party software module 163. The mapping may identify an enterprise application 121 that incorporates the third-party software module 163. Based on receiving input data that includes the vulnerability data, data describing the third-party software module 163, and data describing the enterprise application 121, the generative AI model 147 may generate (a) a recommendation for remediating the vulnerability in the enterprise application 121 and (b) another enterprise application that was not included in the mapping 143. The mapping engine 142 may designate the additional application as a candidate for mapping to the third-party software module 163. Alternatively, the mapping engine 142 may modify the mapping 143 to map the additional application to the third-party software module 163.

In some embodiments, the mapping engine 142 generates or updates the mapping 143 based on a mapping trigger. For example, when a new third-party software module 163 is introduced to the third-party software module registry 141, the mapping engine 142 may analyze the module 163 to determine whether or not to map one or more enterprise applications 121 to the module 163. Additionally, or alternatively, when a new vulnerability is identified associated with a third-party software module 163 stored in the registry 141, the mapping engine 142 may analyze enterprise applications 121 to determine whether or not to modify the mapping 143 to map one or more enterprise applications 121 to the third-party software module 163.

The enterprise application development platform 110, enterprise repository 120, enterprise application execution environment 130, and the enterprise-wide application security platform 140 may be connected via a network 102. In some embodiments, the network 102 is a LAN that includes wired interconnections and wireless communications connections. In some embodiments, elements of the network 102 may include communications over a wide-area network such as the Internet.

The enterprise-wide application security platform 140 includes a machine learning engine 144. The machine learning engine 144 trains a generative AI model 147 using a training dataset 145 to generate recommended remediation paths to remediate vulnerabilities in enterprise applications 121.

As illustrated in FIG. 1B, machine learning engine 144 includes input/output module 181, data preprocessing module 182, model selection module 183, training module 184, evaluation and tuning module 185, and inference module 186.

In accordance with an embodiment, input/output module 181 serves as the primary interface for data entering and exiting the system, managing the flow and integrity of data. This module may accommodate a wide range of data sources and formats to facilitate integration and communication within the machine learning architecture.

In an embodiment, an input handler within input/output module 181 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 181 to be versatile in different operational contexts, whether processing historical datasets or streaming data.

In accordance with an embodiment, input/output module 181 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 181 includes an output framework designed to handle the distribution and exportation of outputs, predictions, or insights. Using the output framework, input/output module 181 formats these outputs into user-friendly and accessible formats, such as reports, visualizations, or data files compatible with other systems. Input/output module 181 also ensures secure and efficient transmission of these outputs to end-users or other systems in an embodiment and may employ encryption and secure data transfer protocols to maintain data confidentiality.

In accordance with an embodiment, data preprocessing module 182 transforms data into a format suitable for use by other modules in machine learning engine 144. For example, data preprocessing module 182 may transform raw data into a normalized or standardized format suitable for training ML models and for processing new data inputs for inference. In an embodiment, data preprocessing module 182 acts as a bridge between the raw data sources and the analytical capabilities of machine learning engine 144.

In an embodiment, data preprocessing module 182 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 182 may be configured to handle anomalies in different ways depending on context. Data preprocessing module 182 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 182 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 182 processes new data for inference, data preprocessing module 182 replicates the same preprocessing steps to ensure consistency with the training data format. This helps to avoid discrepancies between the training data format and the inference data format, thereby reducing the likelihood of inaccurate or invalid model predictions.

In an embodiment, model selection module 183 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 183 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 183 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 183 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 183 also considers computational efficiency and resource constraints. This is meant to help ensure the selected model is both accurate and practical in terms of computational and time requirements. In an embodiment, certain features of model selection module 183 are configurable such as a configured bias toward (or against) computational efficiency.

In accordance with an embodiment, training module 184 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 184 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 184 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 184 includes logic to handle different types of data and learning tasks. For instance, it includes different training routines for supervised learning (where the training data comes with labels) and unsupervised learning (without labeled data). In the case of deep learning models, training module 184 also manages the complexities of training neural networks that include initializing network weights, choosing activation functions, and setting up neural network layers.

In an embodiment, evaluation and tuning module 185 incorporates dynamic feedback mechanisms and facilitates continuous model evolution to help ensure the system's relevance and accuracy as the data landscape changes. Evaluation and tuning module 185 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 185 performs continuous model tuning by using hyperparameter optimization. Evaluation and tuning module 185 performs an exploration of the hyperparameter space using algorithms, such as grid search, random search, or more sophisticated methods like Bayesian optimization. Evaluation and tuning module 185 uses these algorithms to iteratively adjust and refine the model's hyperparameters - settings that govern the model's learning process but are not directly learned from the data - to enhance the model's performance. This tuning process helps to balance the model's complexity with its ability to generalize and attempts to avoid the pitfalls of underfitting or overfitting.

In an embodiment, evaluation and tuning module 185 integrates data feedback and updates the model. Evaluation and tuning module 185 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 185 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 185 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 186 transforms data raw data into actionable, precise, and contextually relevant predictions. In addition to processing and applying a trained model to new data, inference module 186 may also include post-processing logic that refines the raw outputs of the model into meaningful insights.

In an embodiment, inference module 186 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 186 transforms the outputs of a trained model into definitive classifications. Inference module 186 employs the underlying model as a tool to generate probabilistic outputs for each potential class. It then engages in an interpretative process to convert these probabilities into concrete class labels.

In an embodiment, when inference module 186 receives the probabilistic outputs from the model, it analyzes these probabilities to determine how they are distributed across some or every potential class. If the highest probability is not significantly greater than the others, inference module 186 may determine that there is ambiguity or interpret this as a lack of confidence displayed by the model.

In an embodiment, inference module 186 uses thresholding techniques for applications where making a definitive decision based on the highest probability might not suffice due to the critical nature of the decision. In such cases, inference module 186 assesses if the highest probability surpasses a certain confidence threshold that is predetermined based on the specific requirements of the application. If the probabilities do not meet this threshold, inference module 186 may flag the result as uncertain or defer the decision to a human expert. Inference module 186 dynamically adjusts the decision thresholds based on the sensitivity and specificity requirements of the application, subject to calibration for balancing the trade-offs between false positives and false negatives.

In accordance with an embodiment, inference module 186 contextualizes the probability distribution against the backdrop of the specific application. This involves a comparative analysis, especially in instances where multiple classes have similar probability scores, to deduce the most plausible classification. In an embodiment, inference module 186 may incorporate additional decision-making rules or contextual information to guide this analysis, ensuring that the classification aligns with the practical and contextual nuances of the application.

In regression models, where the outputs are continuous values, inference module 186 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 186 incorporates domain-specific adjustments into its post-processing routine. This involves tailoring the model's output to align with specific industry knowledge or contextual information. For example, in financial forecasting, inference module 186 may adjust predictions based on current market trends, economic indicators, or recent significant events, ensuring that the outputs are both statistically accurate and practically relevant.

In an embodiment, inference module 186 includes logic to handle uncertainty and ambiguity in the model's predictions. In cases where inference module 186 outputs a measure of uncertainty, such as in Bayesian inference models, inference module 186 interprets these uncertainty measures by converting probabilistic distributions or confidence intervals into a format that can be easily understood and acted upon. This provides users with both a prediction and an insight into the confidence level of that prediction. In an embodiment, inference module 186 includes mechanisms for involving human oversight or integrating the instance into a feedback loop for subsequent analysis and model refinement.

In an embodiment, inference module 186 formats the final predictions for end-user consumption. Predictions are converted into visualizations, user-friendly reports, or interactive interfaces. In some systems, like recommendation engines, inference module 186 also integrates feedback mechanisms, where user responses to the predictions are used to continually refine and improve the model, creating a dynamic, self-improving system.

Referring to FIG. 1A, in an embodiment, machine learning engine API 146 allows for applications to leverage machine learning engine 144. In an embodiment, machine learning engine API 146 may be built on a RESTful architecture and offer stateless interactions over standard HTTP/HTTPS protocols. Machine learning engine API 146 may feature a variety of endpoints, each tailored to a specific function within machine learning engine 144. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 146 is equipped to support SOAP-based interactions. This extension involves defining a WSDL (Web Services Description Language) document that outlines the API's operations and the structure of request and response messages. In an embodiment, machine learning engine API 146 supports various data formats and communication styles. In an embodiment, machine learning engine API 146 endpoints may handle requests in JSON format or any other suitable format. For example, machine learning engine API 146 may process XML, and it may also be engineered to handle more compact and efficient data formats, such as Protocol Buffers or Avro, for use in bandwidth-limited scenarios.

In an embodiment, machine learning engine API 146 is designed to integrate WebSocket technology for applications necessitating real-time data processing and immediate feedback. This integration enables a continuous, bi-directional communication channel for a dynamic and interactive data exchange between the application and machine learning engine 144.

Referring to FIG. 1C, the machine learning engine 144 trains the generative AI model 147 to generate remediation path predictions or recommendations for remediating vulnerabilities in applications associated with third-party software modules.

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times. In one embodiment, the generative AI model 147 is an LLM.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 181, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 182 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 183, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 184, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 185 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 186, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

As illustrated in FIG. 1C, in an embodiment, the generative AI model 147 is a transformer-type machine learning model. The generative AI model 147 includes a set of encoder stacks 171 and a set of decoder stacks 174. Each encoder stack in the set of encoder stacks 171 includes a multi-attention head mechanism 172 and a feed-forward neural network 173. Each decoder stack in the set of decoder stacks 174 includes a multi-attention head mechanism 175, a feed-forward neural network 176, and a fine-tuning head for generating remediation path predictions 177. In one embodiment, the generative AI model 147 is a fine-tuned large language model (LLM).

Each encoder in the set of encoder stacks 171 includes a multi-attention head 172 that provides a self-attention mechanism. Likewise, each decoder in the set of decoder stacks 174 includes a multi-head attention mechanism 175. The attention mechanism dynamically determines weights for elements of input tokens of an input vector based on input queries and element keys. The result of the attention mechanism is a combined representation of an input sequence. The model 147 generates the combined representation by concatenating the outputs from multiple attention heads, where each attention head focuses on different aspects of the input sequence. The model 147 then applies a linear transformation to the concatenated output. The multi-attention head 172 allows the encoder 171 to simultaneously focus on different aspects of an input sequence by running multiple independent attention mechanisms (i.e., “heads”) in parallel. Focusing on different aspects of the set of input elements allows the encoder 171 to encode embeddings representing input data with additional data representing relationships between elements within the set of input data elements.

The feed-forward neural network 173 converts the output from the multi-head attention mechanism 172 into a set of output sequences that include a word vector embedding sequence and a positional encoder sequence. The word vector embeddings are numerical representations of text. The positional encoding sequence represents the relative positions of words in the word vector embedding sequence. Each sub-layer of the encoder stacks 171 receives an output from the previous sub-layer and applies the attention mechanism 172 and neural network 173 to the output from the previous sub-layer to generate a new output embedding representing the input sequence. Likewise, each sub-layer of the decoder stacks 174 receives an output from the previous sub-layer and applies the attention mechanism 175 and neural network 176 to the output from the previous sub-layer to generate a new output embedding representing the input sequence. Unlike the encoder stacks 171, the final layer of the decoder stacks 174 outputs a sequence of words instead of an embedding representing the input sequence.

The generative AI model 147 includes a fine-tuning head for remediation path prediction 177. In one embodiment, one or more final layers of the final decoder stack among the decoder stacks 174 is removed. A new set of neural layers is added to the final feed-forward neural network 176. The model 147 is then re-trained on a dataset including (a) application data, (b) vulnerability data, and (c) remediation path data for remediating vulnerabilities in software modules incorporated within applications. However, in retraining the model, each neural layer of each neural network 173 and 176, other than the fine-tuning head 177, is frozen. In other words, the model maintains constant the parameters (e.g., offsets and weights) of the neurons in the neural networks 173 and 176 other than the parameters of the neurons in the fine-tuning head 177. In another embodiment, the fine-tuning head 177 is appended to the final layer of the final feed-forward neural network 176 without removing any layers from the final feed-forward neural network 176.

The generative AI model 147 generates a set of remediation path data 149 based on receiving input data including (a) application data associated with enterprise applications 121 and (b) vulnerability data 191 associated with third-party software modules 163. The enterprise-wide application security platform 140 stores the remediation path data 149 in a remediation path repository 148.

In one or more embodiments, a data repository, such as the repository 120 or the repository 148, is any type of storage unit and/or device (e.g., a file system, database, collection of tables, or any other storage mechanism) for storing data. Furthermore, a data repository may include multiple different storage units and/or devices. The multiple different storage units and/or devices may or may not be of the same type or located at the same physical site. Furthermore, a data repository may be implemented or executed on the same computing system as the enterprise-wide application security platform 140. Additionally, or alternatively, a data repository may be implemented or executed on a computing system separate from the enterprise-wide application security platform 140. A data repository may be communicatively coupled to the enterprise-wide application security platform 140 via a direct connection or via a network.

Information describing enterprise applications 121, a security specification 122, or remediation path data 149 may be implemented across any of components within the system 100. However, this information is illustrated within the data repositories 120 and 148 for purposes of clarity and explanation.

The machine learning engine 144 retrains the generative AI model 147 as additional vulnerabilities are identified, remediation paths recommended, and results of remediation path implementations are reported. In particular, the machine learning engine 144 trains the fine-tuning head 177 with a training dataset 145 that includes (a) application data, (b) vulnerability data, and (c) remediation path data. Remediation path data includes (i) a description of operations to be performed to remediate a vulnerability and (ii) a label indicating if implementation of the remediation path successfully remediated the vulnerability. Upon identifying a new vulnerability in a third-party software module 163, mapping the module 163 to one or more applications 121, and generating remediation path recommendations for remediating the vulnerability in the one or more applications, the machine learning engine 144 updates the training dataset 145 for training the fine-tuning head 177 with the newly-identified vulnerability data and remediation path recommendations. Additionally, the machine learning engine 144 may further update the training dataset 145 with a label indicating whether implementation of a remediation path resulted in success or failure.

As an example, a developer may provide feedback that implementing a sequence of operations specified in a remediation path was insufficient to remediate a vulnerability. The developer may further identify an additional set of operations that were required to remediate the vulnerability. The machine learning engine 144 may modify the training dataset 145 with two new sets of training records. A first set of training records specifies that the recommended remediation path was insufficient to remediate the vulnerability. A second set of training records specifies that the remediation path and the additional set of operations specified by the developer were sufficient to remediate the vulnerability. The machine learning engine 144 retrains the fine-tuning head 177 of the generative AI model 147 with the updated dataset 145.

The enterprise-wide application security platform 140 includes a vulnerability remediation engine 150. The vulnerability remediation engine 150 includes a vulnerability data extraction module 151. The vulnerability data extraction module obtains the vulnerability data 191 from the vulnerability publication platform 190. For example, the vulnerability publication platform 190 may be implemented as a database that stores vulnerability data 191 for open-source software modules and applications. An example of a database that stores vulnerability data for software modules is the National Vulnerability Database (NVD). In the embodiment where the vulnerability publication platform 190 is a database or another data repository, the vulnerability data extraction module 151 may include a database query engine to generate queries to the vulnerability publication platform 190. The vulnerability data extraction module 151 may query the vulnerability publication platform 190 on a predefined schedule (such as weekly) or when a trigger is detected. For example, a trigger may include the addition of a new third-party software module 163 in the third-party software module registry 141.

According to another embodiment, the vulnerability publication platform 190 may push vulnerability notifications to recipients. A recipient may manage notifications to receive vulnerability notifications associated with specified third-party software modules. For example, one recipient may request notifications of any identified vulnerability in any third-party software modules 163. Another recipient may request notifications of certain types of vulnerabilities. Another recipient may request notifications for a set of third-party software modules 163 specified by the recipient. The vulnerability data extraction module 151 obtains vulnerability data 191 and identifies third-party software modules 163 specified in the registry 141 to determine if potential vulnerabilities exist among enterprise applications 121.

The vulnerability remediation engine 150 includes a software scanning module 152. The software scanning module 152 performs one or more software scanning operations on software artifacts, including third-party software modules 163 and/or enterprise applications 121, to determine if vulnerabilities exist. In some embodiments, the third-party software module registry 141 stores specimens or copies of software modules under development by a development team. Stored software artifacts may include third-party software modules 163, executable files that incorporate third-party software modules 163, and additional proprietary software code, code segments, and complete copies of executable files for executing enterprise applications 121 on computing devices. For example, a development team may incorporate a third-party messaging application module into a proprietary project development platform. The third-party software module registry 141 may store (a) a cop of the third-party messaging application module and/or (b) a software code file corresponding to the proprietary project development platform that includes the third-party messaging application. The software scanning module 152 may scan stored software code artifacts to determine if potential vulnerabilities are present in the software artifacts. For example, vulnerability data 191 may identify a security vulnerability in a third-party software module 163 if a set of register values is kept at a default set of values. The software scanning module 152 may scan a software artifact in the third-party software module registry 141 to determine if an application 121 incorporating the third-party software module 163 modified the set of register values or kept the values at the default. If the application 121 modified the values, the software scanning module 152 may determine that the vulnerability does not exist in the application 121.

The enterprise-wide application security platform 140 may scan software artifacts using the software scanning module 152 at different stages of software development. For example, the software scanning module 152 may scan portions of software while an application is under development and not yet completed. The software scanning module 152 may scan uncompiled software code and compiled software code. The software scanning module 152 may scan executable software artifacts that, when executed, would run a completed application on a client device.

A remediation monitoring module 153 monitors the enterprise application development platform 110 and the enterprise application execution environment 130 to determine if remediation paths identified for enterprise applications 121 have been implemented. Once a vulnerability has been detected in an enterprise application 121, the remediation monitoring module 153 sends alerts to entities associated with the application 121 and verifies the software build cycles until the remediation monitoring module 153 receives verification that the vulnerability has been remediated. Remediation module 153 not only monitors the software build cycles to track the remediation, but also tracks and monitors the external databases and systems, such as the national vulnerability database (NVD), the common vulnerabilities and exposure database (CVE), and other databases, to constantly keep the remediation database updated with the latest on the vulnerability to escalate the alerts or de-escalate the alerts based on the priority changes to the vulnerability in those databases.

The remediation monitoring module 153 provides contextual data, such as a vulnerability score and a remediation path, to relevant entities associated with a vulnerable application 121. The remediation monitoring module 153 also audits the software release cycle for the application 121 until the remediation monitoring module 153 receives verification that the vulnerability has been remediated.

Once one or more enterprise applications 121 have been identified as being susceptible to a vulnerability, the remediation monitoring module 153 stores information about the applications and monitors the status of the applications to determine if recommended remediation paths have been implemented. For example, the generative AI model 147 may recommend a remediation path for an enterprise application 121 specified in the mapping 143. The application 121 may be under development in the enterprise application development platform 110. The remediation monitoring module 153 transmits a notification to one or more programming clients 111 with instructions for implementing the remediation path to remediate the vulnerability in the application 121. The remediation monitoring module 153 may subsequently detect the application 121 is being designated for deployment in the enterprise application execution environment 130. The remediation monitoring module 153 may prevent the application 121 from being deployed by preventing the application 121 from being executed in the enterprise application execution environment 130 until the remediation monitoring module 153 has determined the remediation path has been implemented, or the vulnerability has been remediated. For example, a developer may implement a remediation path to alter software code that incorporates a third-party software module 163 into the application 121. Alternatively, a developer may modify the application 121 to omit the third-party software module 163. In some embodiments, the remediation monitoring module 153 validates that a remediation path has been implemented or a vulnerability remediated by scanning an application 121. Additionally, or alternatively, the remediation monitoring module 153 may validate that a remediation path has been implemented or a vulnerability remediated by obtaining a confirmation from an employee with a specified authority level.

### 3. Remediating Vulnerabilities From Third-Party Software Modules

FIGS. 2A and 2B illustrate an example set of operations for remediating vulnerabilities in applications that use third-party software modules in accordance with one or more embodiments. One or more operations illustrated in FIGS. 2A and 2B may be modified, rearranged, or omitted. Accordingly, the sequence of operations illustrated in FIGS. 2A and 2B should not be construed as limiting the scope of one or more embodiments.

In an embodiment, a system stores a set of third-party software module data in a registry (Operation 202). In some embodiments, a software security platform invites users to register (a) third-party software modules incorporated in home-grown applications and (b) third-party applications used within an enterprise. Additionally, or alternatively, a software security platform may scan application libraries to identify third-party software modules and applications. The software security platform stores third-party software module data in a central data repository. For example, the software security platform may store a table that specifies third-party software used in an enterprise.

In some embodiments, the system stores specimens or copies of third-party software and/or applications or sub-components of the applications that incorporate the third-party software modules. Additionally, or alternatively, the system may store data that describes the third-party software modules without storing the modules or copies of the modules in the repository.

The system stores a mapping of third-party software modules to applications incorporating the third-party software modules (Operation 204). The mapping specifies a third-party software module and one or more applications or software artifacts that incorporate the third-party software module. The mapping may further specify one or more applications or software artifacts that would be affected by a vulnerability in the third-party software module. For example, if a third-party software module is incorporated in a database-access application to retrieve data from a database, the mapping may identify both (a) the database-access application that retrieves data from the database and (b) an additional set of applications that rely on the database-access application to retrieve data from the database.

The mapping may specify both deployed applications and applications under development. Deployed applications include applications that are in use in an execution environment. The application may be deployed within an enterprise that manages the third-party software module registry. Alternatively, the applications may be deployed by clients or customers external to the enterprise. Applications under development include software artifacts and unfinished portions of software code. The software artifacts may include executable artifacts that are not yet in condition for deployment as fully functional applications in an execution environment. For example, an application specification may include a level of functionality that includes ten different functions. The software artifact may include a level of functionality that includes five different functions and does not yet meet the requirements of the application specification.

The system determines if a vulnerability data extraction trigger is detected (Operation 206). Examples of triggers include detecting a new registration of a new third-party software module and/or a newly-registered application, identifying a new vulnerability associated with a previously-registered software module and/or application, and detecting a change in the development status of a registered application.

In an example where a system queries a vulnerability database, the vulnerability data extraction trigger may be the elapse of a predefined period of time. A system may maintain a schedule of querying the vulnerability database for new vulnerability at regular intervals, such as daily or weekly. Additionally, or alternatively, the system may query the vulnerability database based on detecting a new registration of a third-party software module or an application that incorporates the third-party software module. For example, a software developer in an enterprise may interact with an enterprise software security platform to indicate that the developer is implementing a third-party software module in an application-under development. The system may query the vulnerability database to identify any vulnerabilities associated with the third-party software module.

If the system determines a vulnerability data extraction trigger has been detected, the system extracts vulnerability data from a vulnerability repository (Operation 208). According to one embodiment, a system queries a vulnerability database to extract vulnerability data associated with registered third-party software modules and/or applications. The vulnerability database may be an open source database where members of the public may report vulnerabilities in third-party software modules. Alternatively, the vulnerability database may be a private database maintained by a third party that collects vulnerability data from public and private sources and stores the data in a private database. Vulnerability data includes a type of vulnerability and a software module affected by the vulnerability. Examples of types of vulnerabilities include standard query language (SQL) injection flaws, buffer overflows, cross-site scripting (XSS), improper input validation, privilege escalation issues, unpatched software versions, weak password requirements, insecure network configurations, and vulnerabilities related to specific applications or operating systems.

For example, SQL injection flaws allow malicious code to be injected into a database query, potentially allowing unauthorized access to sensitive data. Cross-site scripting is a web application vulnerability that enables attackers to inject malicious code into a website, potentially stealing user data or performing unauthorized actions. Buffer overflow is a coding error that allows an application to write data beyond the allocated memory buffer, potentially leading to code execution. Improper authentication is a vulnerability where user credentials are not adequately validated, allowing unauthorized access.

Vulnerability data may include a common vulnerability and exposure (CVE) identifier. The CVE identifier is a unique value that allows different platforms to track the same vulnerability. The vulnerability data stored in the vulnerability database may further include a description of the vulnerability, affected software versions, potential impacts, attack vectors, and recommended remediation paths for remediating the vulnerability. The vulnerability data may include a severity score to rank a severity of the vulnerability based on factors such as the exploitability of the vulnerability and its impact on an application.

In some embodiments, a system receives vulnerability data from an external source without detecting a trigger and initiating a query. For example, an enterprise may subscribe to a third-party vulnerability monitoring platform that collects information about third-party software module vulnerabilities and broadcasts the data to subscribers.

Based on a third-party software module specified in the vulnerability data, the system identifies one or more applications mapped to the third-party software module (Operation 210). The system analyzes a mapping of third-party software modules to applications to identify the one or more applications. For example, an enterprise may maintain a registry that maps a third-party software module including functionality to access data in a database to three applications that incorporate the third-party software module to allow the applications to access data in a database maintained by the enterprise. Based on identifying a vulnerability in the third-party software module, the system analyzes the mapping to identify the three applications that incorporate the third-party software module.

The system applies a generative AI model, such as a large language model (LLM), to a set of input data including the vulnerability data to generate one or more remediation paths for one or more applications (Operation 212). Applying the generative AI model to the input data includes generating an input prompt for the generative AI model. The input prompt includes vulnerability data and application data. As discussed above, the vulnerability data includes a description of a vulnerability. The vulnerability data may further include a third-party software that includes the vulnerability. The application data includes a set of applications specified in the mapping as being associated with the third-party software module that has the vulnerability. In some embodiments, the vulnerability data includes recommended remediation data. For example, a third-party vulnerability database may store vulnerability data and a recommended remediation path for remedying the vulnerability. The generative AI model may generate a recommendation that matches the recommendation stored in the vulnerability database or that differs from the recommendation stored in the vulnerability database.

In some embodiments, the mapping stores one-to-many relationship data of a single third-party software module to two or more applications managed or under development within an enterprise. Generating the prompt for the generative AI model may include (a) specifying the vulnerability data and (b) specifying application data for the two or more applications mapped to the third-party module that has been identified as being susceptible to the vulnerability. In some embodiments, a system divides a prompt into multiple separate prompts that correspond to multiple separate applications. Upon receiving multiple separate output recommendations from the generative AI model, the system may merge the multiple separate recommendations into a single set of text content to provide to a user.

In some embodiments, the application data includes a description of a type of application, such as a user interface application, a database access application, a communications application, or an application directed to a particular organization, such as a human resources application, a production management application, or a financial management application. The application data may include functions performed by the application, including if the application provides a user interface as well as how the application accesses, manipulates, and presents data. Application data may include types of data that are input to the application and types of data that are output from the application. In some embodiments, a system may obtain application data by analyzing an application programming interface (API) specification of the application.

Based on the input prompt, the generative AI model generates a recommended remediation path for remediating a vulnerability in an application. The recommendation is a prediction generated by the generative AI based on training the fine-tuning head of the generative AI on a training dataset that includes vulnerability data, application data, and remediation path data.

Remediation paths include sequences of operations to remediate vulnerabilities. Examples of remediation paths include recommendations to alter software code, modifying security settings in an application, omitting a third-party software application from an application, applying a software patch to an application, and modifying an application to include one or more additional third-party software modules.

For example, the generative AI may generate a recommendation to modify source code of the third-party software module to remediate a vulnerability. Additionally, or alternatively, the generative AI may generate a recommendation to modify settings that are adjustable at run-time to remediate the vulnerability. According to yet another example, the generative AI may generate a recommendation to modify application source code, other than the third-party software module, to remediate the vulnerability in the third-party software module.

Since different applications may implement the same third-party software modules in different ways, the generative AI model may generate different recommendations for remediating the same vulnerability in the same third-party software module that has been incorporated in different applications. A remediation recommendation for one application may involve modifying source code of the third-party software module. A remediation recommendation for another application may involve changing settings in the application at run-time.

Since the generative AI model is trained on a dataset that includes all the applications maintained by an enterprise and not just the applications specified in the prompt, the generative AI model may generate remediation recommendations for one or more additional applications that were not identified in the input prompt. For example, a system may generate an input prompt specifying a vulnerability in a third-party software module and two applications that incorporate the third-party software module. The generative AI may generate two separate remediation recommendations for the two applications. However, the generative AI may further generate an additional remediation recommendation for an additional application that was not specified in the input prompt. The additional application may (or may not) incorporate the third-party software module. For example, the generative AI may identify relationships between the vulnerability data associated with the third-party software module and application attributes of the additional application that do not incorporate the third-party software module. In this manner, the generative AI model may provide an enterprise with an added level of security beyond that provided by querying a vulnerability database to identify vulnerabilities in applications supported by the enterprise.

In some embodiments, the generative AI model generates additional remediation data. For example, the generative AI model may generate a vulnerability severity score representing an urgency of remediating the vulnerability. As an example, vulnerability data obtained from a vulnerability may include one vulnerability severity score. However, the generative AI model trained on application data of applications in a proprietary system and environment may learn via training that the combination of two or more software modules results in a greater vulnerability of an application than indicated by the score included with the vulnerability data. Accordingly, the generative AI model may generate a different, higher score representing a greater severity of the vulnerability based on the application data of the proprietary application associated with a third-party software module.

The generative AI model, trained on a comprehensive dataset covering all enterprise-managed applications has the capability to recommend remediation actions for additional applications beyond those explicitly mentioned in the input list. Furthermore, the system automatically updates the remediation registry with this data, ensuring a centralized, up-to-date repository for tracking and managing remediation efforts across the enterprise. This process enhances visibility and streamlines decision-making for application management.

Based on identifying the vulnerable applications and remediation paths, the system initiates remediation operations to remediate vulnerabilities in the applications. The system selects a vulnerable application (Operation 214). The system may select a first application based on determining the vulnerability corresponds to a higher priority level in the first application than in a second application. For example, a vulnerability associated with inadequate authentication may be assigned a higher priority in an application that is accessed by many users than in an application that is accessed by one or two users. A system may assign a higher priority to an application where a vulnerability exposes a database to external hackers than to another application where the vulnerability exposes the database to data recording errors from within an enterprise.

Referring to FIG. 2B, the system determines if a specimen or copy of a software artifact associated with a vulnerable application is stored in the registry (Operation 216). A system may allow users to selectively store specimens or copies of software artifacts that incorporate third-party software modules in the registry. An enterprise may selectively require software artifacts incorporating third-party software modules to be stored in the registry. For example, an enterprise may require stored copies of software artifacts for any applications that are deployed within the enterprise or deployed to customers or clients. The enterprise may not require stored copies of software artifacts incorporating third-party software modules for applications that are still under development and not yet deployed.

As another example, an enterprise may permit anonymous registration of third-party software modules. Anonymous registration may allow a user to specify a third-party software module and an application incorporating the third-party software module without storing copies of software artifacts in the registry.

If the system determines a software artifact incorporating a third-party software module is stored in the registry, the system performs security scans of the software artifact to determine if the vulnerability is present in the software artifact (Operation 218). Examples of software scans include vulnerability scans, port scans, web application scans, static application security testing (SAST), software composition analysis (SCA), network scans, penetration testing, and authenticated scanning. Vulnerability scans use the vulnerability data obtained from the vulnerability database to determine if the identified vulnerability is present in the software artifact. For example, a vulnerability may be associated with a third-party software module having insufficient authentication. If a developer fails to modify the modification requirements in the software artifact, the system may determine the vulnerability exists. However, if the developer modifies the authentication requirements, the system may determine that the vulnerability does not exist in the software artifact that incorporates the third-party software module. As another example, an SAST scan may analyze source code of a software artifact or application to identify the vulnerability in the artifact or application without executing the artifact or application.

If the system determines the vulnerability is present in the software artifact (Operation 222), the system initiates vulnerability remediation. In one embodiment, the system transmits remediation path data to an entity associated with the application mapped to the third-party software module (Operation 224). In addition, if the system determines in operation 216 that a copy of a software artifact is not stored in the registry, the system transmits the remediation path data to the entity (Operation 224) without performing the scanning operations of Operation 222.

An entity associated with an application may include any entity identified in the registry as being associated with the application. For example, the entity may include a software development team, a software security team, an information technology (IT) group, users, and/or customers. Transmitting remediation path data may include transmitting a set of instructions to be carried out by an entity to remediate the vulnerability. In some examples, the sequence of instructions may be implemented as a runbook maintained and monitored by a runbook execution platform.

In one or more embodiments, a system may isolate a vulnerable application until the vulnerability is remediated. A system may determine whether or not to isolate an application based on a severity of a vulnerability. A system may allow users to continue to use an application where an identified vulnerability has a low likelihood of affecting data and/or a marginal effect on data if the vulnerability is exploited. In contrast, the system may isolate an application to prevent its use if a vulnerability has a high likelihood of affecting data and/or an effect of the vulnerability would have a significant negative impact on an enterprise or customers.

In one or more embodiments, a system may isolate the functionality of a third-party software module from the functionality of the rest of an application. For example, the system may determine that the third-party software module is accessed with one instruction to perform a non-vital function. The system may disable the instruction in the application until the vulnerability is addressed and remediated.

In some embodiments, a system may automatically, without user input, initiate a sequence of operations to remediate the vulnerability. The system may generate a notification to entities associated with a vulnerable application that the system performed the operations specified in the remediation plan to remediate the vulnerability. For example, the system may alter software to change a security setting, such as a password setting, to require entry of a password or implementation of a more rigorous password. The system may change a security setting to modify permission settings for an application. For example, the system may change a set of data sources and other applications a vulnerable application is permitted to access.

Based on scanning a software artifact, the system may determine that the vulnerability identified in the vulnerability database does not exist in the software artifact. For example, a software programmer may have modified code in the third-party software module or in an application incorporating the third-party software module to remediate the vulnerability. If the system determines that the vulnerability associated with the third-party software module is not present in the software artifact stored in the registry, the system determines if any additional application is mapped to the third-party software module (Operation 226). The system may refer to the mapping of software modules to applications stored in the registry. If another application is identified in the mapping as being associated with the vulnerable third-party software module, the system returns to operation 214 to select the application for vulnerability analysis.

In addition, the system determines if the generative AI model identified any additional software modules and/or applications associated with the vulnerability. If the generative AI model identified an additional application as being associated with a vulnerability, the system may select the application in operation 214 for a vulnerability analysis.

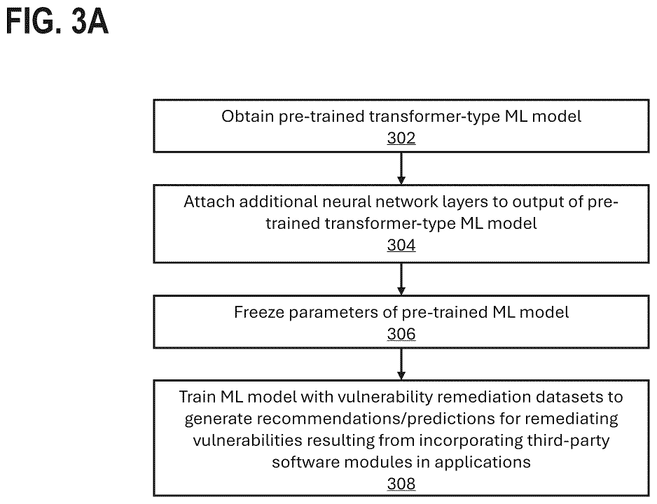

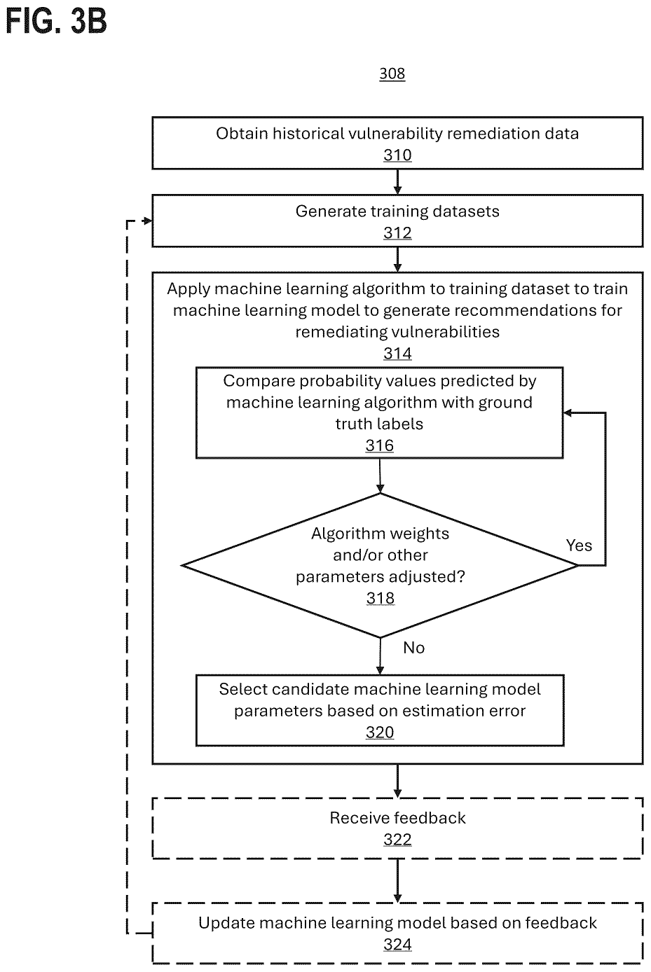

In addition, if the system determines the generative AI model identified an additional third-party software module as corresponding to a vulnerability, the system may modify the mapping in the registry to identify the vulnerability. Additionally, the system may perform operations 214-224 to determine if the third-party software module identified by the generative AI included the vulnerability. If the vulnerability was not present in a software artifact incorporating the third-party software module identified by the generative AI model, the system may modify a training dataset and retrain the fine-tuning head of the generative AI model to specify that the predicted vulnerability was not present in the third-party software module. Conversely, if the vulnerability was present in a software artifact incorporating the third-party software module identified by the generative AI model, the system may modify the training dataset and retrain the fine-tuning head of the generative AI model to specify that the predicted vulnerability was present in the third-party software module. A description of operations for training the generative AI model is provided in FIGS. 3A and 3B to follow.

### 4. Training a Transformer-Type Machine Learning Model to Recommend Remediation Paths

A detailed example is described below for purposes of clarity. Components and/or operations described below should be understood as one specific example that may not be applicable to certain embodiments. Accordingly, components and/or operations described below should not be construed as limiting the scope of any of the claims.

Referring to FIG. 3A, a system obtains a pre-trained machine learning model (Operation 302). In one embodiment, the pre-trained machine learning model is a generative AI model. The generative AI model may be a transformer-type machine learning model such as an LLM. The generative AI model is trained on a dataset that includes a broad vocabulary to learn relationships among words and grammatical rules. The generative AI model is trained to receive a sequence of tokens that represent words and sub-words as input data and to generate an embedding representing the sequence as output data. The embedding is a multi-dimensional numerical vector.

The system creates a fine-tuning head by attaching an additional neural network layer to the output of the pre-trained ML model (Operation 304). Adding the classification head results in generating a different type of output data from the pre-trained ML model. While the pre-trained ML model is configured to receive sequences of tokens as input data and generate human-understandable words as output data, the classification head is configured to receive the embeddings from the pre-trained ML model as input data and generate, in a human-understandable format (such as words arranged in sentences), recommendations for remediation paths to remediate vulnerabilities in applications incorporating third-party software modules.

The system freezes the parameters of the pre-trained ML model (Operation 306). The offsets and coefficients of the pre-trained ML model are set at their pre-trained values to prevent the parameters from changing in subsequent training of the fine-tuned ML model, including the fine-tuning head.

The system trains generative AI model that includes the pre-trained model and the fine-tuning head with vulnerability remediation datasets to generate recommendations for remediating vulnerabilities (Operation 308). During fine-tuning of the generative AI model, the parameters of the pre-trained ML model remain frozen while the system modifies the parameters of the neurons that make up the fine-tuning head.

FIG. 3B describes the training of the generative AI model to recommend remediation paths for remediating vulnerabilities in further detail. In one or more embodiments, a system (e.g., one or more components of system 100 illustrated in FIG. 1) obtains historical vulnerability remediation data (Operation 310). Obtaining the historical vulnerability remediation data may include obtaining historical and synthetic records specifying (a) a vulnerability, (b) vulnerability data describing the vulnerability, (c) third-party software module data describing a third party-software module including the vulnerability, (d) application data describing an application incorporating the third-party software module, (e) a remediation path associated with remediating the vulnerability, and (f) an indication of a success or failure of the remediation path to remediate the vulnerability.

The system uses the historical and synthetic vulnerability remediation data to generate a set of training data (Operation 312). The set of training data includes, for a particular set of vulnerability remediation data, at least one classification label. The classification label specifies if a remediation path successfully remediated a vulnerability in an application.

According to one embodiment, the system obtains the historical vulnerability remediation data and the training data set from a data repository storing labeled data sets. According to one embodiment, the system generates the labeled set of data by parsing documents and generating labels based on parsed values in the documents. According to an alternative embodiment, one or more users generate labels for a data set.

In some embodiments, generating the training data set includes generating a set of feature vectors for the labeled examples. A feature vector, for example, may be n-dimensional, where n represents the number of features in the vector. The number of features that are selected may vary depending on the implementation. The features may be curated in a supervised approach or automatically selected from extracted attributes during model training and/or tuning. Example features include information about a vulnerability (e.g., vulnerability type and severity), information about a third-party software module, and information about an application incorporating the third-party software module. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if a type of healthcare service has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 314). For example, the machine learning algorithm may analyze the training data set to train neurons of a neural network in the classification head of the ML model with particular weights and offsets to associate particular vulnerability and application data with particular remediation path operations. The system trains the neurons of the neural network of the classification head without modifying neurons of the pre-trained ML model.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data.

In some embodiments, the system compares the probability values estimated through the one or more iterations of the machine learning model algorithm with ground truth labels to determine an estimation error (Operation 316). The system may perform this comparison for a test set of examples that may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error (Operation 318). Adjustments may be made until a candidate model that minimizes the estimation error or otherwise achieves a threshold level of estimation error is identified. The process may return to Operation 318 to adjust and continue training the machine learning model.

In some embodiments, the system selects machine learning model parameters based on the estimation error meeting a threshold accuracy level (Operation 320). For example, the system may select a set of parameter values for a machine learning model based on determining that the trained model has an accuracy level for predicting remediation paths for vulnerabilities in applications incorporating third-party software modules of at least 98%.

In some embodiments, the system trains a neural network of the classification head using backpropagation without applying the backpropagation to the pre-trained ML model. Backpropagation is a process of updating cell states in the neural network based on gradients determined as a function of the estimation error. With backpropagation, nodes are assigned a fraction of the estimated error based on the contribution to the output and adjusted based on the fraction.

In embodiments in which the machine learning algorithm is a supervised machine learning algorithm, the system may optionally receive feedback on the various aspects of the analysis described above (Operation 322). For example, the feedback may affirm or revise labels generated by the machine learning model. The machine learning model may predict a remediation path for remediating a vulnerability in an application incorporating a third-party software module. The system may receive feedback indicating that an additional set of steps, in addition to the predicted remediation path, was required to remediate the vulnerability. Based on the feedback, the machine learning training set may be updated (Operation 324), thereby improving its analytical accuracy. Once updated, the system may further train the machine learning model by optionally applying the model to additional training data sets.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

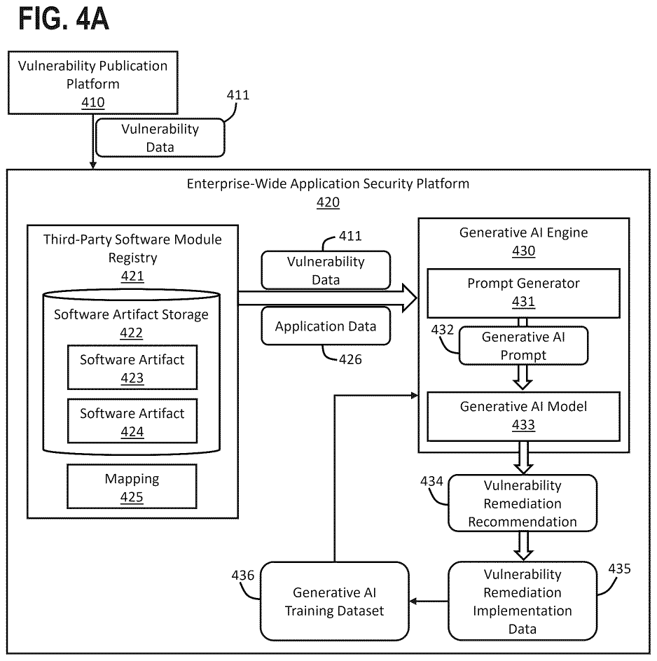

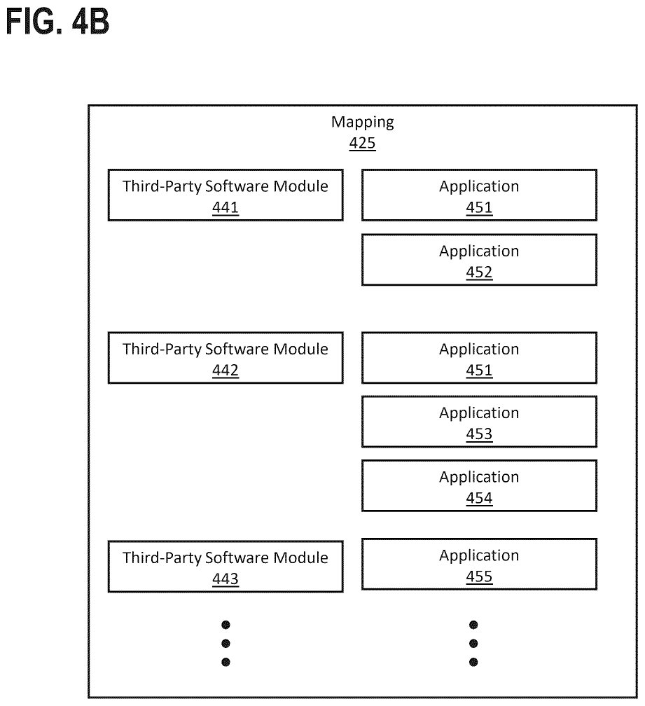

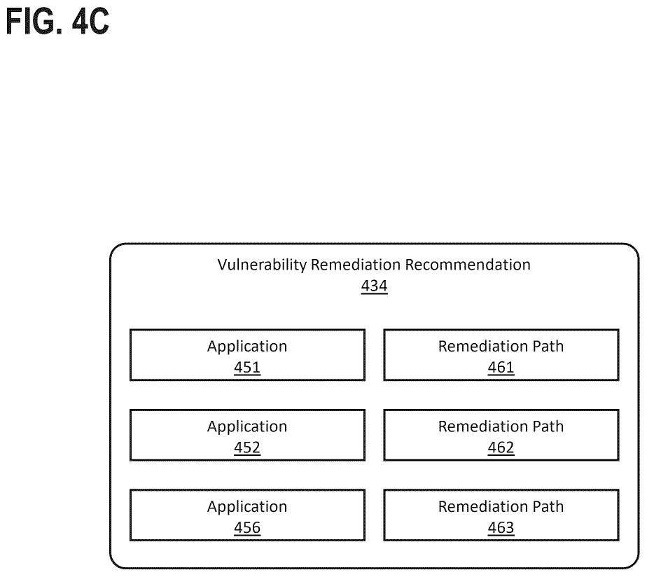

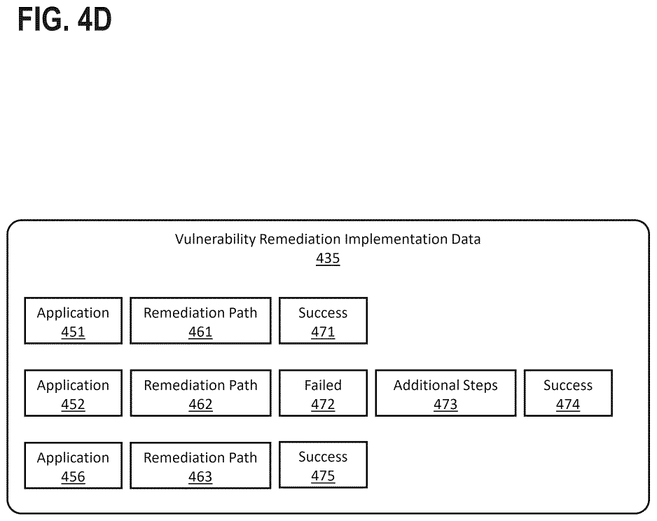

FIGS. 4A to 4D illustrate a system and operations for remediating vulnerabilities in applications that use third-party software modules. An enterprise-wide security platform 420 obtains vulnerability data 411 from a vulnerability publication platform 410. The vulnerability publication platform 410 may be embodied as a vulnerability database storing vulnerability data for open-source software modules and other third-party software modules.

The enterprise-wide application security platform maintains a third-party software module registry 421. The third-party software module registry 421 includes software artifact storage 422. The software artifact storage 422 stores software artifacts 423 and 424 that incorporate third-party software modules. Third-party software module registry 421 also stores and maintains a mapping 425 of third-party software modules to applications. FIG. 4B illustrates an example of a mapping 425.

Referring to FIG. 4B, the mapping specifies third-party software module 441 incorporated in application 451 and application 452. The mapping 425 further specifies third-party software module 442 incorporated in application 451, application 453, and application 454. The mapping 425 further specifies third-party software module 443 incorporated in application 455.

The vulnerability data 411 describes an improper identification-type vulnerability in third-party software module 441. The platform 420 identifies application 451 and application 452 as being associated with the software module 441. The platform 420 provides the vulnerability data 411 and application data associated with application 451 and application 452 to a generative AI engine 430.

The generative AI engine 430 includes a prompt generator 431. The prompt generator 431 generates a generative AI prompt 432 that includes the vulnerability data 411 and the application data 426. The prompt generator 431 may generate a first prompt that includes the vulnerability data 411 and the application data associated with application 451. The prompt generator 431 may generate a second prompt that includes the vulnerability data 411 and the application data associated with application 452.

The generative AI engine 430 includes the prompt(s) 432 to the generative AI model 433 to generate a vulnerability remediation recommendation 434. The generative AI model 433 is an LLM-type model including a fine-tuning head trained on a data set, including vulnerability data, application data, and remediation data.

FIG. 4C illustrates an example of a vulnerability remediation recommendation 434. The generative AI model 433 generates a recommended remediation path 461 to remediate the vulnerability in application 451. The generative AI model 433 generates a recommended remediation path 462 to remediate the vulnerability in application 452. The generative AI model 433 generates a recommended remediation path 463 to remediate the vulnerability in application 456. While applications 451 and 452 were specified in the mapping 425 as incorporating the third-party software module 441, application 456 was not specified in the mapping 425 as incorporating the third-party software module 441. Instead, the generative AI model 433 learned via training on a training dataset, including vulnerability data, application data, and remediation data, that the vulnerability specified in the vulnerability data 411 may also affect application 456. The generative AI model 433 also learned via training a recommended remediation path 463.

The remediation path 461 includes a first set of operations to modify a portion of software code in application 451 corresponding to the third-party software module 441 incorporated in the application 451. The remediation path 462 includes a first set of operations to modify run-time settings in application 452 to require a password to access a data access portal. The remediation path 463 includes a third set of operations to modify run-time settings in application 456 to require a password to access a data access portal.

The enterprise-wide application security platform 420 obtains vulnerability remediation implementation data 435 based on implementing vulnerability remediation recommendations in the vulnerability remediation recommendation 434. The vulnerability remediation implementation data 435 may be generated by a computing system implementing remediation recommendations, by users implementing remediation recommendations, or both.

Referring to FIG. 4D, the vulnerability remediation implementation data 435 includes results data 471 indicating that applying the remediation path 461 to remediate the vulnerability in application 451 was a success. The vulnerability remediation implementation data 435 includes results data 472 indicating that applying the remediation path 462 to remediate the vulnerability in application 452 was a failure. The vulnerability remediation implementation data 435 further includes results data 474 indicating that applying a set of additional steps 473 to remediate the vulnerability in application 452 resulted in a success. For example, the remediation path 462 includes a first set of operations to modify run-time settings in application 452 to require a password to access a data access portal. A programmer may determine that the password could not be set up in the application 452 at run-time unless a set of source code was also modified to allow for setting up the password. The additional steps 473 may include a set of operations identified by the programmer to modify the application source code.

The vulnerability remediation implementation data 435 includes results data 475 indicating that applying the remediation path 463 to remediate the vulnerability in application 456 was a success.

The generative AI engine 430 generates a generative AI training dataset 436 that incorporates the vulnerability remediation implementation data 435. The generative AI training dataset 436 includes a dataset previously used to train the generative AI model 433 and a set of training data records based on the new results obtained from the vulnerability remediation implementation data 435. For example, one set of training data records may specify that applying the remediation path 461 to remediate the vulnerability in application 451 was a success. Another set of training data records may specify that applying the remediation path 462 to remediate the vulnerability in application 452 was a failure. Yet another set of training data records may specify that supplementing the remediation path 462 with additional steps 473 resulted in a successful vulnerability remediation. Yet another set of training data records may specify that applying the remediation path 463 to remediate the vulnerability in application 456 was a success. The training data records may include historical records data and synthetic records generated by the generative AI engine 430 to supplement the historical records data.

Based on the generative AI training dataset 436, the generative AI engine 430 retrains the fine-tuning head of the generative AI model 433 without retraining additional layers of the generative AI model 433. In addition, based on determining that applying the remediation path 463 to remediate the vulnerability in application 456 was a success, the enterprise-wide application security platform 420 may update the mapping 425 to specify the application 456 is mapped to the third-party software module 441 even if the third-party software module may not be incorporated in the application 456.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same overlay network.

### 7. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

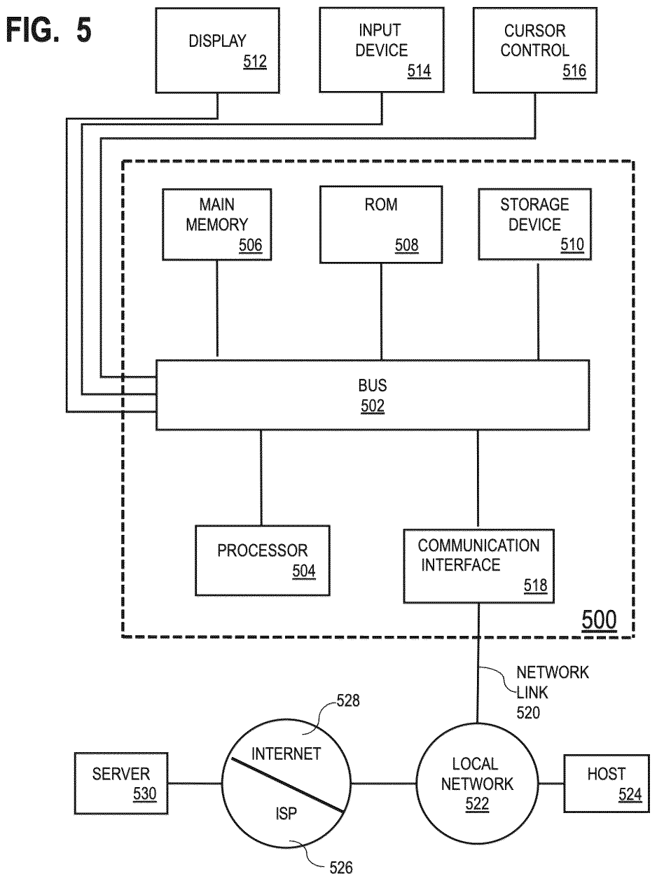

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a LAN card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
extracting first vulnerability data associated with a vulnerability in a first software module from a software vulnerability repository comprising descriptions of vulnerabilities in one or more of a set of software modules;
accessing a registry comprising a mapping of the set of software modules to applications, wherein the mapping indicates that the first software module is included in a first application, and wherein the mapping indicates that the first software module is included in a second application, wherein the first application and the second application are independently executing applications;
responsive to identifying the vulnerability in the first software module: identifying both the first application and the second application that incorporate the first software module based on the mapping;
submitting (a) the first vulnerability data, and (b) first application data associated with the first application and (c) second application data associated with the second application to a generative artificial intelligence (AI) model,
wherein the generative AI model is trained to recommend remediation paths for remediating vulnerabilities in applications based on vulnerability data;
determining, by the generative AI model, a first remediation path specifying a first set of operations for remediating the vulnerability in the first application;
initiating a first remediation process based on the first remediation path to remediate the vulnerability associated with the first application;
determining, by the generative AI model, a second remediation path specifying a second set of operations for remediating the vulnerability in the second application; and
initiating a second remediation process based on the second remediation path to remediate the vulnerability associated with the second application.

2. The non-transitory computer readable media of claim 1, wherein the first remediation path is applied to the first application to remediate the vulnerability in the first application.

3. The non-transitory computer readable media of claim 1, wherein the operations further comprise:
training the generative AI model to recommend remediation paths for remediating vulnerabilities in applications at least by:
generating a training data set comprising (a) the descriptions of the vulnerabilities in the software modules, (b) the mapping of the set of software modules to the applications, (c) application data including attributes of the applications identified in the registry, and (d) remediation paths associated with the vulnerabilities in the software modules; and
training the generative AI model based on the training data set.

4. The non-transitory computer readable media of claim 3, wherein the operations further comprise:
determining the first remediation path has been implemented in the first application; and
re-training the generative AI model based on a set of remediation data associated with implementing the first remediation path in the first application.

5. The non-transitory computer readable media of claim 1, wherein the operations further comprise:
training the generative AI model to generate recommendations for remediating vulnerabilities at least by:
obtaining a pre-trained transformer-type machine learning model;
generating a neural network layer to receive an output from the pre-trained transformer-type machine learning model;
obtaining a plurality of training data sets, a training data set of the plurality of training data sets comprising:
the descriptions of the vulnerabilities in the software modules;
application data including attributes of the applications identified in the registry;
remediation paths associated with the vulnerabilities in the software modules; and
at least one label associated with implementing a remediation path; and
applying the plurality of training data sets to a machine learning algorithm to determine first parameters for the generative AI model at least by:
freezing second parameters of the pre-trained transformer-type machine learning model while modifying third parameters of the neural network layer based on an error function.

6. The non-transitory computer readable media of claim 1, wherein the operations further comprise:
determining, by the generative AI model, a third remediation path specifying a third set of operations for remediating the vulnerability in a third application,
wherein the third application is not associated with the vulnerability in the software vulnerability repository.

7. The non-transitory computer readable media of claim 1, wherein the operations further comprise:
based on determining the first software module is stored in the registry, scanning the first software module to identify a set of software code affected by the vulnerability; and
based on determining a second software module associated with the second application is not stored in the registry:
identifying an entity mapped to the second application; and
transmitting a notification to the entity, the notification specifying the second software module, the vulnerability, and the second remediation path.

8. The non-transitory computer readable media of claim 1, wherein the first application is under development,
wherein the operations further comprise detecting, by a software development platform, a change in a development status of the first application; and
based on detecting the change in the development status of the first application: determining whether the first remediation path has been implemented in the first application.

9. A method comprising:
extracting first vulnerability data associated with a vulnerability in a first software module from a software vulnerability repository comprising descriptions of vulnerabilities in one or more of a set of software modules;
accessing a registry comprising a mapping of the set of software modules to applications, wherein the mapping indicates that the first software module is included in a first application, and wherein the mapping indicates that the first software module is included in a second application, wherein the first application and the second application are independently executing applications;
responsive to identifying the vulnerability in the first software module: identifying both the first application and the second application that incorporate the first software module based on the mapping;
submitting (a) the first vulnerability data, and (b) first application data associated with the first application and (c) second application data associated with the second application to a generative artificial intelligence (AI) model,
wherein the generative AI model is trained to recommend remediation paths for remediating vulnerabilities in applications based on vulnerability data;
determining, by the generative AI model, a first remediation path specifying a first set of operations for remediating the vulnerability in the first application;
initiating a first remediation process based on the first remediation path to remediate the vulnerability associated with the first application;
determining, by the generative AI model, a second remediation path specifying a second set of operations for remediating the vulnerability in the second application; and
initiating a second remediation process based on the second remediation path to remediate the vulnerability associated with the second application,
wherein the method is performed by at least one device including a hardware processor.

10. The method of claim 9, wherein the first remediation path is applied to the first application to remediate the vulnerability in the first application.

11. The method of claim 9, further comprising:
training the generative AI model to recommend remediation paths for remediating vulnerabilities in applications at least by:
generating a training data set comprising (a) the descriptions of the vulnerabilities in the software modules, (b) the mapping of the set of software modules to the applications, (c) application data including attributes of the applications identified in the registry, and (d) remediation paths associated with the vulnerabilities in the software modules; and
training the generative AI model based on the training data set.

12. The method of claim 11, further comprising:
determining the first remediation path has been implemented in the first application; and
re-training the generative AI model based on a set of remediation data associated with implementing the first remediation path in the first application.

13. The method of claim 9, further comprising:
training the generative AI model to generate recommendations for remediating vulnerabilities at least by:
obtaining a pre-trained transformer-type machine learning model;
generating a neural network layer to receive an output from the pre-trained transformer-type machine learning model;
obtaining a plurality of training data sets, a training data set of the plurality of training data sets comprising:
the descriptions of the vulnerabilities in the software modules;
application data including attributes of the applications identified in the registry;
remediation paths associated with the vulnerabilities in the software modules; and
at least one label associated with implementing a remediation path; and
applying the plurality of training data sets to a machine learning algorithm to determine first parameters for the generative AI model at least by:
freezing second parameters of the pre-trained transformer-type machine learning model while modifying third parameters of the neural network layer based on an error function.

14. The method of claim 9, further comprising:
determining, by the generative AI model, a third remediation path specifying a third set of operations for remediating the vulnerability in a third application,
wherein the third application is not associated with the vulnerability in the software vulnerability repository.

15. The method of claim 9, further comprising:
based on determining the first software module is stored in the registry, scanning the first software module to identify a set of software code affected by the vulnerability; and
based on determining a second software module associated with the second application is not stored in the registry:
identifying an entity mapped to the second application; and
transmitting a notification to the entity, the notification specifying the second software module, the vulnerability, and the second remediation path.

16. The method of claim 9, wherein the first application is under development,
wherein the operations further comprise detecting, by a software development platform, a change in a development status of the first application; and
based on detecting the change in the development status of the first application: determining whether the first remediation path has been implemented in the first application.

17. A system comprising:
at least one device including a hardware processor;
the system being configured to perform operations comprising:
extracting first vulnerability data associated with a vulnerability in a first software module from a software vulnerability repository comprising descriptions of vulnerabilities in one or more of a set of software modules;
accessing a registry comprising a mapping of the set of software modules to applications, wherein the mapping indicates that the first software module is included in a first application, and wherein the mapping indicates that the first software module is included in a second application, wherein the first application and the second application are independently executing applications;
responsive to identifying the vulnerability in the first software module: identifying both the first application and the second application that incorporate the first software module based on the mapping;
submitting (a) the first vulnerability data, and (b) first application data associated with the first application and (c) second application data associated with the second application to a generative artificial intelligence (AI) model,
wherein the generative AI model is trained to recommend remediation paths for remediating vulnerabilities in applications based on vulnerability data;
determining, by the generative AI model, a first remediation path specifying a first set of operations for remediating the vulnerability in the first application;
initiating a first remediation process based on the first remediation path to remediate the vulnerability associated with the first application;
determining, by the generative AI model, a second remediation path specifying a second set of operations for remediating the vulnerability in the second application; and
initiating a second remediation process based on the second remediation path to remediate the vulnerability associated with the second application.

18. The system of claim 17, wherein the first remediation path is applied to the first application to remediate the vulnerability in the first application.

19. The system of claim 17, wherein the operations further comprise:
training the generative AI model to recommend remediation paths for remediating vulnerabilities in applications at least by:
generating a training data set comprising (a) the descriptions of the vulnerabilities in the software modules, (b) the mapping of the set of software modules to the applications, (c) application data including attributes of the applications identified in the registry, and (d) remediation paths associated with the vulnerabilities in the software modules; and
training the generative AI model based on the training data set.

20. The system of claim 19, wherein the operations further comprise:
determining the first remediation path has been implemented in the first application; and
re-training the generative AI model based on a set of remediation data associated with implementing the first remediation path in the first application.
